(19) United States
(12) Patent Application Publication
(10) Pub. No.: US 2024/0080997 A1
(43) Pub. Date: Mar. 7, 2024

(54) DISPLAY MODULE AND PREPARATION METHOD THEREOF, AND DISPLAY DEVICE

(71) Applicant: Shanghai Tianma Microelectronics Co., Ltd., Shanghai (CN)

(72) Inventor: Shouzheng WU, Shanghai (CN)

(73) Assignee: Shanghai Tianma Microelectronics Co., Ltd., Shanghai (CN)

(21) Appl. No.: 18/389,258

(22) Filed: Nov. 14, 2023

(30) Foreign Application Priority Data
Mar. 31, 2023 (CN) 202310342795.3

(51) Int. Cl. H05K 5/00

(52) U.S. Cl. CPC H05K 5/0021

(57) ABSTRACT

A display module includes backplanes and at least two display panels disposed on a side of the backplanes. The backplanes include a first backplane and a second backplane disposed opposite to each other and glue between the two. The first backplane includes communication holes extending through the first backplane. The second backplane includes glue filling holes extending through the second backplane. The glue fills the glue filling holes. The display panels are located on the side of the second backplane facing away from the first backplane, overlap the glue filling holes in the thickness direction of the display module, and are adhered to the second backplane by the glue in the glue filling holes.

### CROSS-REFERENCE TO RELATED APPLICATION

This application claims priority to Chinese Patent Application No. 202310342795.3 filed Mar. 31, 2023, the disclosure of which is incorporated herein by reference in its entirety.

### TECHNICAL FIELD

The present disclosure relates to the field of display panel technology and, in particular, to a display module and a preparation method thereof, and a display device.

### BACKGROUND

Since there are more and more application scenarios of display panels, the size of the existing monolithic display panel cannot satisfy the requirement of a scenario of a large display area. To solve this problem, it is necessary to combine multiple display panels to form a combination panel having a large image.

However, when multiple display panels are combined, there are still some problems that affect the overall display effect to be solved.

### SUMMARY

Embodiments of the present disclosure provide a display module and a preparation method thereof, and a display device. In the display module, communication holes in a first backplane and glue filling holes in a second backplane ensure stable fixing of a display panel, thereby ensuring the stability of the structure of the display module and the overall display effect of the display module.

In an aspect, an embodiment of the present disclosure provides a display module. The drive module includes backplanes and at least two display panels disposed on a side of the backplanes.

The backplanes include a first backplane and a second backplane disposed opposite to each other and glue between the first backplane and the second backplane. The first backplane includes communication holes extending through the first backplane. The second backplane includes glue filling holes extending through the second backplane. The glue fills the glue filling holes.

The display panels are located on the side of the second backplane facing away from the first backplane, overlap the glue filling holes in the thickness direction of the display module, and are adhered to the second backplane by the glue in the glue filling holes.

In another aspect, an embodiment of the present disclosure provides a preparation method of a display module. The method includes the steps below.

The backplanes are provided. The backplanes include the first backplane and the second backplane disposed opposite to each other. The first backplane includes the communication holes extending through the first backplane. The second backplane includes the glue filling holes extending through the second backplane.

At least two display panels are placed on the side of the second backplane facing away from the first backplane. Air extraction is performed on the backplanes at a first air extraction rate through at least part of the communication holes so that the display panels are fixed on the surface of the second backplane.

Glue injection is performed on the backplanes through at least part of the communication holes to fill the glue between the first backplane and the second backplane and in the glue filling holes so that the display panels are adhered to the second backplane by the glue in the glue filling holes.

In another aspect, an embodiment of the present disclosure provides a display device. The device includes the display module described above.

### BRIEF DESCRIPTION OF DRAWINGS

To illustrate solutions in embodiments of the present disclosure more clearly, the accompanying drawings used in description of the embodiments are briefly described below. The accompanying drawings described below illustrate part of the embodiments of the present disclosure, and those of ordinary skill in the art may obtain other accompanying drawings based on the accompanying drawings described below on the premise that no creative work is done.

FIG. 1 is a view illustrating the structure of a display module according to an embodiment of the present disclosure.

FIG. 2 is a section view taken along section line A-A′ of FIG. 1.

FIG. 3 is a diagram illustrating the structure of a first backplane according to an embodiment of the present disclosure.

FIG. 4 is a section view taken along section line B-B′ of FIG. 3.

FIG. 5 is a diagram illustrating the structure of a second backplane according to an embodiment of the present disclosure.

FIG. 6 is a section view taken along section line C-C′ of FIG. 5.

FIG. 7 is another section view taken along section line A-A′ of FIG. 1.

FIG. 8 is a diagram illustrating the structure of another first backplane according to an embodiment of the present disclosure.

FIG. 9 is a diagram illustrating the structure of another first backplane according to an embodiment of the present disclosure.

FIG. 10 is a diagram illustrating the structure of another display panel according to an embodiment of the present disclosure.

FIG. 11 is a diagram illustrating the structure of another display panel according to an embodiment of the present disclosure.

FIG. 12 is a diagram illustrating the structure of another first backplane according to an embodiment of the present disclosure.

FIG. 13 is a diagram illustrating the structure of another second backplane according to an embodiment of the present disclosure.

FIG. 14 is a diagram illustrating the structure of another first backplane according to an embodiment of the present disclosure.

FIG. 15 is a diagram illustrating the structure of another first backplane according to an embodiment of the present disclosure.

FIG. 16 is a diagram illustrating the structure of another first backplane according to an embodiment of the present disclosure.

FIG. 17 is a diagram illustrating the control structure of a communication hole according to an embodiment of the present disclosure.

FIG. 18 is a diagram illustrating the structure of another first backplane according to an embodiment of the present disclosure.

FIG. 19 is a diagram illustrating the structure of another first backplane according to an embodiment of the present disclosure.

FIG. 20 is a diagram illustrating the structure of another second backplane according to an embodiment of the present disclosure.

FIG. 21 is a diagram illustrating the structure of another second backplane according to an embodiment of the present disclosure.

FIG. 22 is a section view taken along section line D-D′ of FIG. 21.

FIG. 23 is a diagram illustrating the structure of another second backplane according to an embodiment of the present disclosure.

FIG. 24 is a section view taken along section line E-E′ of FIG. 23.

FIG. 25 is a diagram illustrating the structure of another second backplane according to an embodiment of the present disclosure.

FIG. 26 is a section view taken along section line F-F′ of FIG. 25.

FIG. 27 is a diagram illustrating the structure of another second backplane according to an embodiment of the present disclosure.

FIG. 28 is another section view taken along section line A-A′ of FIG. 1.

FIG. 29 is a flowchart of a preparation method of a display module according to an embodiment of the present disclosure.

FIG. 30 is a flowchart of another preparation method of a display module according to an embodiment of the present disclosure.

FIG. 31 is a flowchart of another preparation method of a display module according to an embodiment of the present disclosure.

FIG. 32 is a flowchart of another preparation method of a display module according to an embodiment of the present disclosure.

FIG. 33 is a flowchart of another preparation method of a display module according to an embodiment of the present disclosure.

FIG. 34 is a diagram illustrating the structure of a display device according to an embodiment of the present disclosure.

### DETAILED DESCRIPTION

The solutions in embodiments of the present disclosure are described clearly and completely in conjunction with the drawings in the embodiments of the present disclosure from which the solutions are better understood by those skilled in the art. The embodiments described below are part, not all, of the embodiments of the present disclosure. Based on the embodiments described herein, all other embodiments obtained by those skilled in the art on the premise that no creative work is done are within the scope of the present disclosure.

It is to be noted that the terms “first” and “second” in the description, claims, and drawings of the present disclosure are used to distinguish between similar objects and are not necessarily used to describe a particular order or sequence. It should be understood that the data used in this way is interchangeable where appropriate so that the embodiments of the present disclosure described herein can also be implemented in a sequence not illustrated or described herein. In addition, the terms “comprising”, “including” or any other variations thereof herein are intended to encompass a non-exclusive inclusion. For example, a system, product, or device that includes a series of units not only includes those expressly listed steps or units but may also include other units that are not expressly listed or are inherent to such product or device.

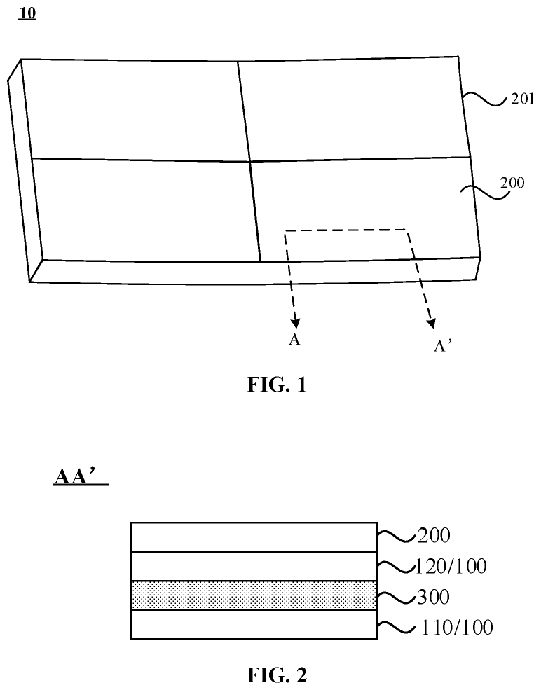

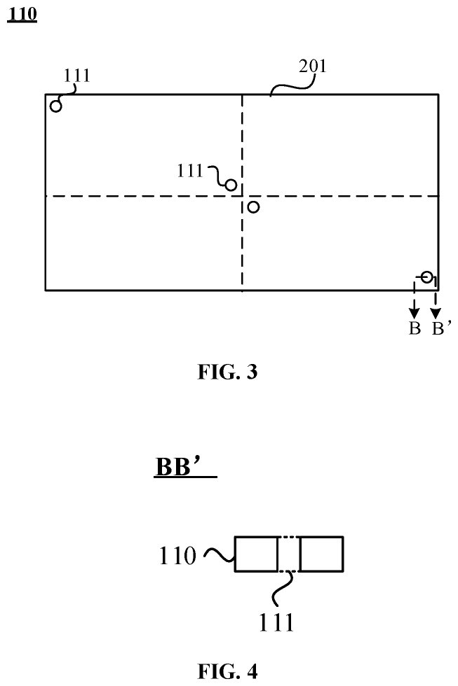

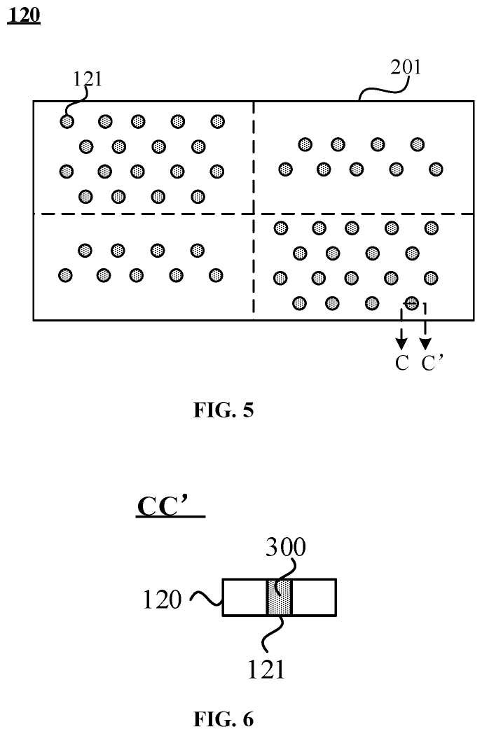

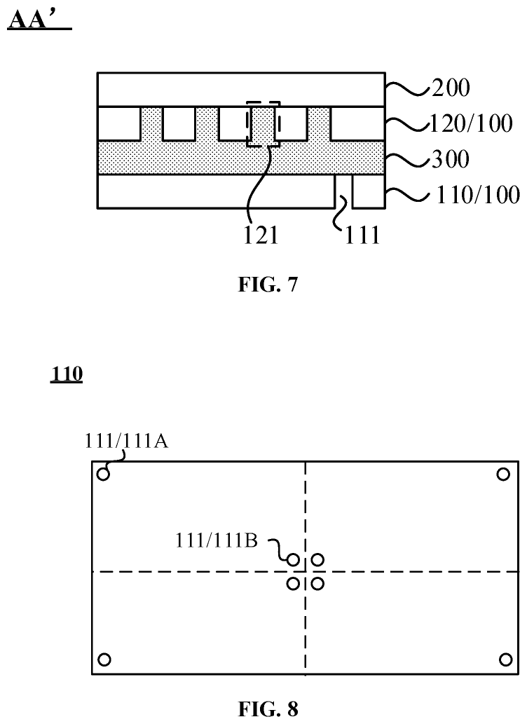

FIG. 1 is a view illustrating the structure of a display module according to an embodiment of the present disclosure. FIG. 2 is a section view taken along section line A-A′ of FIG. 1. FIG. 3 is a diagram illustrating the structure of a first backplane according to an embodiment of the present disclosure. FIG. 4 is a section view taken along section line B-B′ of FIG. 3. FIG. 5 is a diagram illustrating the structure of a second backplane according to an embodiment of the present disclosure. FIG. 6 is a section view taken along section line C-C′ of FIG. 5. FIG. 7 is another section view taken along section line A-A′ of FIG. 1. With reference to FIGS. 1 to 7, an embodiment of the present disclosure provides a display module 10. The drive module 10 includes backplanes 100 and at least two display panels 200 disposed on a side of the backplanes 100. The backplanes 100 include a first backplane 110 and a second backplane 120 disposed opposite to each other and glue 300 between the first backplane 110 and the second backplane 120. The first backplane 110 includes communication holes 111 extending through the first backplane 110. The second backplane 120 includes glue filling holes 121 extending through the second backplane 120. The glue 300 fills the glue filling holes 121. The display panels 200 are located on the side of the second backplane 120 facing away from the first backplane 110, overlap the glue filling holes 121 in the thickness direction of the display module 10, and are adhered to the second backplane 120 by the glue 300 in the glue filling holes 121.

The display module 10 includes a display panel 200. The display panel 200 has a display function, thereby implementing the display effect of the display module 10. For example, the display panel 200 may be a liquid-crystal display panel or may be an organic light-emitting display panel. The specific type of the display panel 200 is not limited in this embodiment of the present disclosure. Further, the display module 10 includes at least two display panels 200, that is, multiple display panels 200 may be combined and spliced, thereby implementing the display effect of a large size of the display module 10 and ensuring the better overall display effect of the display module 10.

Further, with reference to FIG. 2, the display module 10 also includes backplanes 100. The backplanes 100 include the first backplane 110 and the second backplane 120. At the same time, the display panels 200 are located on and adhered to the side of the second backplane 120 facing away from the first backplane 110. That is, the backplanes 100 serve as the support structure for the display panels 200 and provide space for multiple display panels 200 when combined together, thereby ensuring that the display module 10 can implement a display effect of a large area in which multiple display panels 200 are spliced. The glue 300 is disposed between the first backplane 110 and the second backplane 120. The backplanes 100 and the display panels 200 are fixed by the glue 300, thereby ensuring the stability of the structure of the display module 10.

Specifically, with reference to FIG. 3, the first backplane 110 includes communication holes 111. With reference to FIG. 4, the communication holes 111 extend through the first backplane 110. Air extraction is performed through the communication holes 111, and negative pressure is formed in the space between the first backplane 110 and the second backplane 120, so that the display panels 200 are stably adsorbed on the second backplane 120. At the same time, the glue 300 is also injected between the first backplane 110 and the second backplane 120 through the communication holes 111. Further, with reference to FIG. 5, the second backplane 120 includes glue filling holes 121. With reference to FIG. 6, the glue filling holes 121 extend through the second backplane 120. The glue 300 fills the glue filling holes 300, that is, the glue 300 is facilitated to flow between the second backplane 120 and the display panels 200 through the glue filling holes 300, thereby ensuring that the display panels 200 are in fixed contact with the second backplane 120. For example, with reference to FIG. 7, air extraction and glue 300 injection are implemented through the communication holes 111 of the first backplane 110. The glue 300 fills the glue filling holes 121 of the second backplane 120 to ensure that the display panels 200 are adhered to the second backplane 120 by the glue 300 in the glue filling holes 121, thereby ensuring the stability of the overall structure of the display module 10. Moreover, it is ensured that multiple display panels 200 are fixedly disposed in the display module 10, thereby implementing a display effect of a large size. Further, the overall display module 10 may be planar or curved, that is, based on the communication holes and the glue filling holes included in the backplanes 100, it is possible to ensure the structural stability of the display module 10 of various shapes and ensure the display effect of the display module 10.

In summary, the drive module provided by this embodiment of the present disclosure includes backplanes and at least two display panels. The backplanes include the first backplane and the second backplane. The display panels are located on the side of the second backplane facing away from the first backplane. The glue is disposed between the first backplane and the second backplane. Specifically, the first backplane includes the communication holes extending through the first backplane. The second backplane includes the glue filling holes. The glue fills the glue filling holes. The communication holes and the glue filling holes are disposed in the backplanes so that the display panels are fixed on the surface of the second backplane through the communication holes and the glue filling holes, thereby obtaining a display module formed by splicing multiple display panels. In this manner, the structure of the display module is stable, and the display effect is good.

With continued reference to FIGS. 3 and 4, the communication holes 111 are configured for performing air extraction and glue injection on the space between the first backplane 110 and the second backplane 120 in a time-sharing manner.

Specifically, the communication holes 111 in the first backplane 110 have two functions: air extraction and glue injection. Specifically, for air extraction, that is, after the first backplane 110, the second backplane 120, and the display panels 200 are placed at designed relative positions, air extraction is performed through the communication holes 111, and the air between the first backplane 110 and the second backplane 120 is extracted. In this manner, negative pressure is formed between the first backplane 110 and the second backplane 120 relative to other positions. Thus, a pressure difference is formed between the pressure between the first backplane 10 and the second backplane 120 and the atmospheric pressure. Under the action of the pressure difference, the display panels 200 may be adhered to the second backplane 120, so that the display panels 200 are stably fixed at the position of the second backplane 120 during later glue injection. Further, for glue injection, that is, the glue 300 is injected between the first backplane 110 and the second backplane 120 through the communication holes 111 to ensure that the first backplane 110 is adhered to the second backplane 120, thereby ensuring that the first backplane 110 is fixedly connected to the second backplane 120. At the same time, the second backplane 120 includes glue filling holes 121. The glue 300 injected through the communication holes 111 also fills the glue-filling holes 121 and may even flow between the second backplane 120 and the display panels 200 through the glue filling holes 121, so that it is ensured that the second backplane 120 and the display panels 200 may be adhesively connected through the glue in the glue-filling holes 121 or through the glue flowing between the second backplane 120 and the display panels 200, thereby fixing the display panels 200 to the surface of the second backplane 120. In general, glue injection and air extraction are performed through the communication holes 111 to ensure the stable connection of the structure between the first backplane 110, the second backplane 120, and the display panels 200, thereby ensuring the stability of the structure of the display module 10.

Further, for the communication holes 111, the implementation process of glue injection and air extraction is time-sharing, that is, glue injection and air extraction are not completed at the same time. For example, air extraction is first performed through the communication holes 111 to form negative pressure to determine the approximately fixed positions of the display panels 200 on the surface of the second backplane 120, and then glue injection is performed to ensure the overall stable fixed effect of the display panels 200 and the backplanes 100.

FIG. 8 is a diagram illustrating the structure of another first backplane according to an embodiment of the present disclosure. With reference to FIG. 8, part of the communication holes 111 are configured for performing air extraction and glue injection on the space between the first backplane 110 and the second backplane 120 in a time-sharing manner, and the rest of the communication holes 111 are configured for performing glue injection on the space between the first backplane 110 and the second backplane 120.

Specifically, with reference to FIG. 8, the first backplane 110 includes multiple communication holes 111. Based on the fact that the communication holes 111 have two working processes: glue injection and air extraction, that is, multiple communication holes 111 are functionally distinguished. That is, part of the communication holes 111 are only used to implement the glue injection function, and part of the communication holes 111 may have the glue injection function and air extraction function, so that air extraction and glue injection are flexibly set.

For example, with reference to FIG. 8, the first backplane 110 includes multiple communication holes 111. Further, the communication holes 111 include communication holes 111A and communication holes 111B. The communication holes 111A are configured for performing air extraction and glue injection on the space between the first backplane 110 and the second backplane 120 in a time-sharing manner, that is, two working processes of air extraction and glue injection are performed through the communication holes 111A at different times. The communication holes 111B are only configured for performing glue injection on the space between the first backplane 110 and the second backplane 120, that is, the communication holes 111B complete only one working process of glue injection. It is to be noted that in FIG. 8, only part of the communication holes 111 are shown as communication holes 111A or communication holes 111B, and the rest of the communication holes 111 are not specifically shown. In this embodiment of the present disclosure, whether the communication holes 111 at different positions in the first backplane 110 implement one working process or two working processes is not limited.

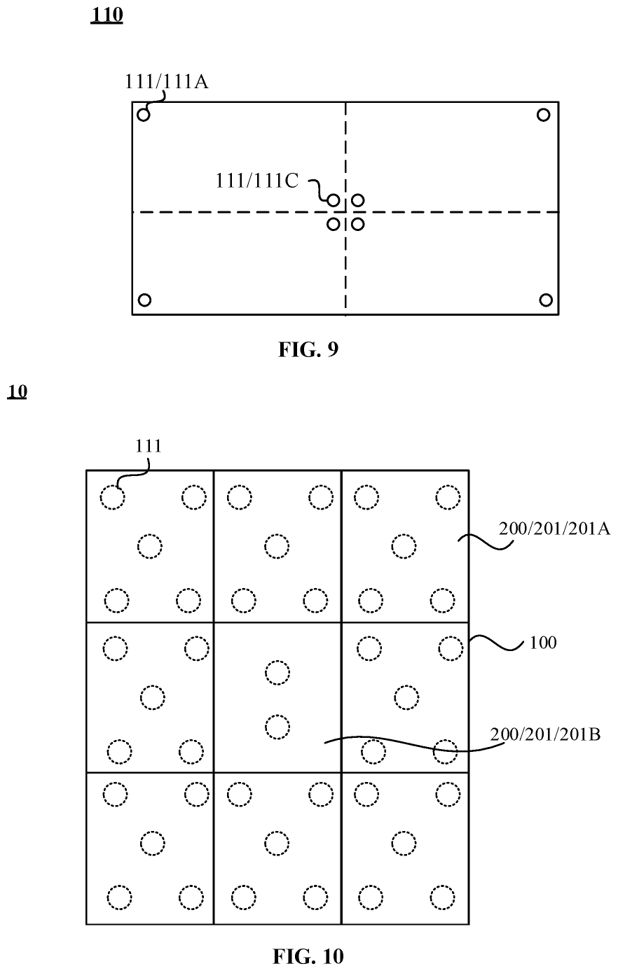

FIG. 9 is a diagram illustrating the structure of another first backplane according to an embodiment of the present disclosure. With reference to FIG. 9, part of the communication holes 111 are configured for performing air extraction and glue injection on the space between the first backplane 110 and the second backplane 120 in a time-sharing manner, and the rest of the communication holes 111 are configured for performing air extraction on the space between the first backplane 110 and the second backplane 120.

Further, the communication holes 111 include communication holes 111A and communication holes 111C. The communication holes 111A are configured for performing air extraction and glue injection on the space between the first backplane 110 and the second backplane 120 in a time-sharing manner, that is, two working processes of air extraction and glue injection are performed through the communication holes 111A at different times. The communication holes 111C are only configured for performing air extraction on the space between the first backplane 110 and the second backplane 120, that is, the communication holes 111C complete only one working process of air extraction. Similarly, it is to be noted that in FIG. 8, only part of the communication holes 111 are shown as communication holes 111A or communication holes 111C, and the rest of the communication holes 111 are not specifically shown. In this embodiment of the present disclosure, whether the communication holes 111 at different positions in the first backplane 110 implement one working process or two working processes is not limited.

FIG. 10 is a diagram illustrating the structure of another display panel according to an embodiment of the present disclosure. With reference to FIG. 10, the backplanes 100 include at least two panel disposition regions 201. The display panels 200 are disposed in the panel disposition regions 201. Two panel disposition regions 201 are disposed. The number of communication holes 111 in a panel disposition region 201 adjacent to an edge of the backplanes 100 is greater than the number of communication holes 111 in a panel disposition region 201 adjacent to the center of the backplanes 100.

Specifically, the backplanes 100 include a panel disposition region 201. The panel disposition region 201 is a region where a display panel 200 is placed. Further, with reference to FIG. 10, a description is given by using an example in which the display module 10 includes nine panel disposition regions 201. The specific number of panel disposition regions 201 may be adjusted adaptively according to actual requirements for the display size. This is not limited in this embodiment of the present disclosure.

Further, with reference to FIG. 10, for two panel disposition regions 201, a panel disposition region 201B adjacent to the center of the backplanes 100 and a panel disposition region 201A far away from the center of the backplanes 100 are used as examples. The number of communication holes 111 in the panel disposition region 201A adjacent to an edge of the backplanes 100 is greater than the number of communication holes 111 in the panel disposition region 201B far away from the edge of the backplanes 100. That is, in FIG. 10, the number of communication holes 111 in the panel disposition region 201A is greater than the number of communication holes 111 in the panel disposition region 201B. It is to be noted that the specific number of communication holes 111 in the panel disposition region 201A and the panel disposition region 201B is not specifically limited, and only an example is shown in the figure. Further, the distribution density of communication holes 111 in the panel disposition region 201A may also be greater than the distribution density of communication holes 111 in the panel disposition region 201B. Based on the difference in the distribution density, the number of the communication holes 111 per unit area may be different. In general, the communication holes 111 in the panel disposition region 201A and the communication holes 111 in the panel disposition region 201B are disposed differently, so that the number of communication holes 111 adjacent to an edge of the backplanes 100 is ensured to be greater. In this manner, the entire edge of the display module 10 is ensured to be fixedly connected better and more stably, thereby ensuring the stability of the overall structure of the display module 10. It is to be noted that FIG. shows the display module 10. In the figure, only internal communication holes 111 are shown by dotted lines. The glue filling holes 121 in the display module 10 are not shown. Thus, the disposition tendency of the communication holes 111 is clearly understood.

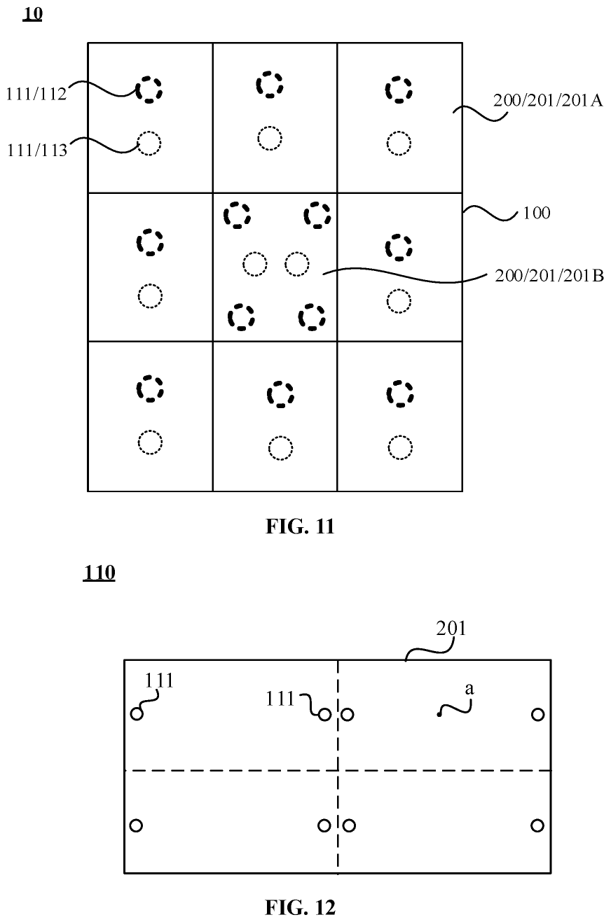

FIG. 11 is a diagram illustrating the structure of another display panel according to an embodiment of the present disclosure. With reference to FIG. 11, the backplanes 100 include at least two panel disposition regions 201. The display panels 200 are disposed in the panel disposition regions 201. The communication holes 111 include glue injection holes 112. The glue injection holes 112 are at least configured for performing glue injection on the space between the first backplane 110 and the second backplane 120. Two panel disposition regions 201 are disposed. The number of glue injection holes 112 in a panel disposition region 201 adjacent to an edge of the backplanes 100 is less than the number of glue injection holes 112 in a panel disposition region 201 adjacent to the center of the backplanes 100.

Specifically, with reference to FIG. 11, a description is given by using an example in which the display module 10 includes two panel disposition regions 201. In FIG. 11, only internal communication holes 111 are shown by dotted lines. The glue filling holes 121 in the display module 10 are not shown. Thus, the disposition tendency of the communication holes 111 is clearly understood. In the figure, the communication holes 111 include glue injection holes 112 for implementing glue injection and air extraction holes 113 for implementing air extraction.

Further, the number of glue injection holes 112 in the panel disposition region 201A adjacent to an edge of the backplanes 100 is less than the number of glue injection holes 112 in the panel disposition region 201B far away from the edge of the backplanes 100. That is, with reference to FIG. 11, the number of glue injection holes 112 in the panel disposition region 201A is less than the number of glue injection holes 112 in the panel disposition region 201B. In other words, based on the difference in the distribution density of glue injection holes 112, there may be a difference in the number of glue injection holes 112, or there may be a difference in the area of glue injection holes 112 in different regions. In general, the glue injection holes 112 are disposed differently according to the size of the distance from the edge of the backplanes 100, so that it is ensured that the glue 300 injected through the glue injection holes 112 may be uniformly diffused to the periphery of the backplanes 100, thereby ensuring the adhesive stability of the display module 10 and ensuring the display effect of the display module 10.

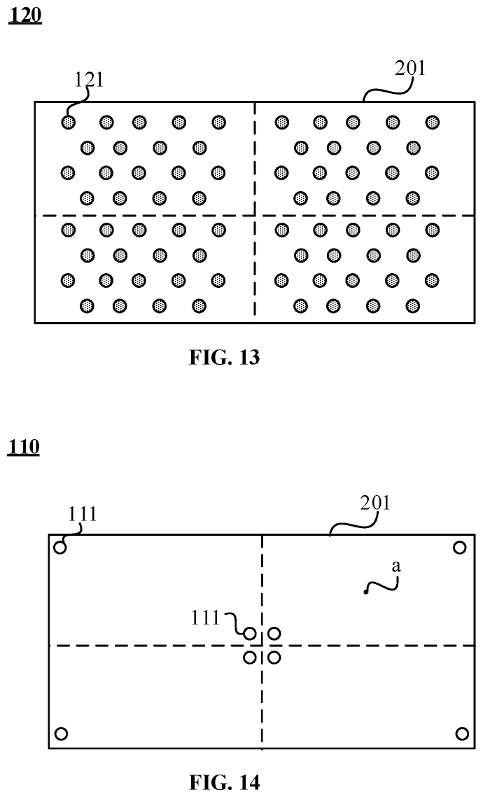

FIG. 12 is a diagram illustrating the structure of another first backplane according to an embodiment of the present disclosure. FIG. 13 is a diagram illustrating the structure of another second backplane according to an embodiment of the present disclosure. With reference to FIGS. 12 and 13, the backplanes 100 include at least two panel disposition regions 201. The display panels 200 are disposed in the panel disposition regions 201. The first backplane 110 in each panel disposition region 201 includes communication holes 111. The second backplane 120 in each panel disposition region 201 includes glue filling holes 121.

The backplanes 100 include communication holes 111 located in the first backplane 110 and glue filling holes 121 located in the second backplane 120. The communication holes 111 and the glue filling holes 121 implement the processes of air extraction, glue injection, and adhesion, thereby ensuring the stability of the structure of the display module 10.

Further, to further ensure the stability of the overall structure of the display module 10, with reference to FIGS. 12 and 13, communication holes 111 may be disposed in the first backplane 110 corresponding to each panel disposition region 201, and glue filling holes 121 may be disposed in the second backplane 120 corresponding to each panel disposition region 201. Communication holes 111 and glue filling holes 121 are disposed in each region. In this manner, the filling effect of the glue in each panel disposition region 201 may be the same or similar. The glue 300 may not be disposed non-uniformly. Thus, it is ensured that the display panel 200 and the backplanes 100 in each different panel disposition region 201 have a good fixed effect, thereby ensuring the stability of the structure of the display module 10.

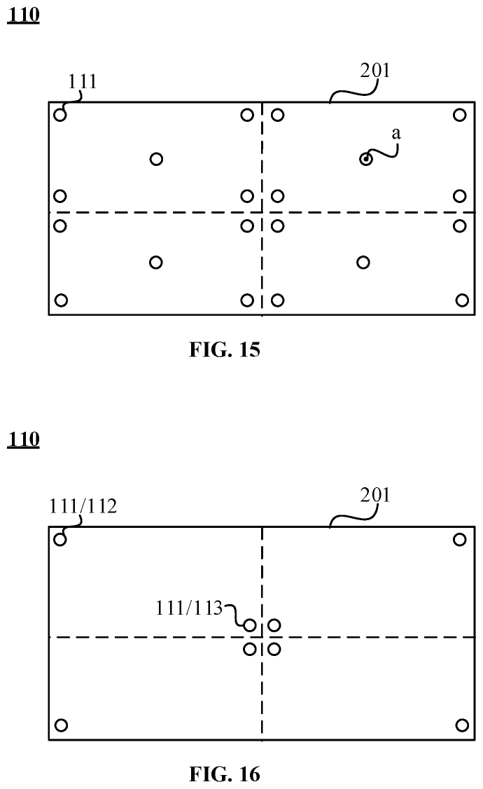

FIG. 14 is a diagram illustrating the structure of another first backplane according to an embodiment of the present disclosure. FIG. 15 is a diagram illustrating the structure of another first backplane according to an embodiment of the present disclosure. With continued reference to FIGS. 12, 14, and 15, in a panel disposition region 201, the first backplane 110 includes at least two communication holes 111. Two communication holes 111 are disposed on two opposite sides of the center a of the panel disposition region 201. Alternatively, at least one communication hole 111 is disposed at the center a of the panel disposition region 201, and at least one communication hole 111 is disposed at an edge of the panel disposition region 201.

The first backplane 110 includes at least two communication holes 111, that is, it is ensured that glue injection and air extraction can be implemented in a time-sharing manner, and it is ensured that glue injection and air extraction may be implemented through different communication holes 111 at the same time. Further, the number of communication holes 111 in the first backplane 110 may be adaptively increased. The number of the communication holes 111 is not limited in this embodiment of the present disclosure. With continued reference to FIGS. 12, 14, and 15, a description is given by using an example in which the first backplane 110 corresponding to each panel disposition region 201 includes two communication holes 111.

For example, with reference to FIGS. 12 and 14, the two communication holes 111 in the first backplane 110 may be located on two opposite sides of the center a of the panel disposition region 201. Whether the two opposite sides are two sides of the center or two sides of a diagonal is not limited in this embodiment of the present disclosure. Based on communication holes 111 disposed on two sides of the center a, during glue injection, communication holes 111 on one side of the center a may be used for glue injection, and communication holes 111 on the other side of the center a may be used for air extraction. In this manner, the glue 300 may flow in the space between the first backplane 110 and the second backplane 120 during glue injection, so that the glue 300 fills the overall flow region, thereby ensuring that different regions of the backplanes 100 have relatively balanced adhesion to the display panels 200. Further, with reference to FIG. 15, at least one communication hole 111 is disposed at the center a of the panel disposition region 201, and at least one communication hole 111 is disposed at an edge of the panel disposition region 201. Regardless of whether the communication holes 111 at the center a are used for glue injection or air extraction, and similarly, regardless of whether the communication holes 111 at the edge are used for air extraction or glue injection, based on dispersed disposition positions, it is advantageous to implement the flow of the glue 300 between the first backplane 110 and the second backplane 120. That is, it is ensured that the glue 300 uniformly fills the overall region, thereby ensuring the adhesive stability of the display module 10.

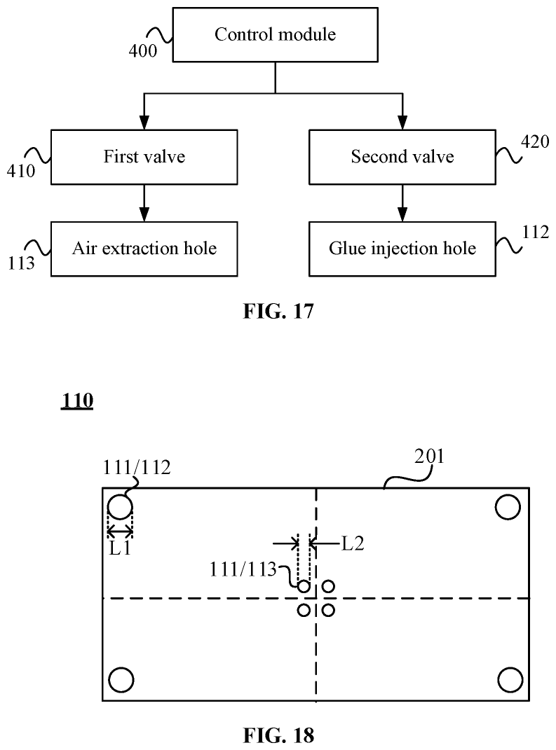

FIG. 16 is a diagram illustrating the structure of another first backplane according to an embodiment of the present disclosure. FIG. 17 is a diagram illustrating the control structure of a communication hole according to an embodiment of the present disclosure. With reference to FIGS. 16 and 17, the communication holes 111 include air extraction holes 113 and glue injection holes 112. The air extraction holes 113 are at least configured for performing air extraction on the space between the first backplane 110 and the second backplane 120. The glue injection holes 112 are at least configured for performing glue injection on the space between the first backplane 110 and the second backplane 120. The air extraction holes 113 and the glue injection holes 112 are independently disposed. The backplane also includes a first valve 410 and a second valve 420. The first valve 410 is configured to control the opening degree state of the air extraction holes 113. The second valve 420 is configured to control the opening degree state of the glue injection holes 112.

Specifically, the communication holes 111 include air extraction holes 113 and glue injection holes 112. The air extraction holes 113 extract the air between the first backplane 110 and the second backplane 120 to form negative pressure to ensure that the display panels 200 are adhered to the second backplane 120. The glue 300 is injected between the first backplane 110 and the second backplane 120 through the glue injection holes 112. The glue 300 flows between the second backplane 120 and the display panels 200 through the glue filling holes 121 in the second backplane 120, thereby ensuring that the display panels 200, the second backplane 120, and the first backplane 110 are closely adhered and ensuring the stability of the structure of the display module 10.

Further, a valve may be configured to adjust the opening degree of the communication holes 111, thereby adjusting the state and rate of air extraction and glue injection. Specifically, with reference to FIG. 16, a control module 400 may control the opening degree state of the first valve 410 and the opening degree state of the second valve 420. An opening degree state includes valve opening, valve closing, and valve partial opening. Since the first valve 410 is connected to the air extraction holes 113, the control module 400 adjusts the air extraction state of the air extraction holes 113 by controlling the opening degree state of the first valve 410. The second valve 420 is connected to the glue injection holes 112. The control module 400 adjusts the glue injection state of the glue injection holes 112 by controlling the opening degree state of the second valve 420. In this manner, the stability of the adjustment of the air extraction holes 113 and the glue injection holes 112 is improved.

For example, if the current display module 10 only needs to ensure that the display panels 200 are adsorbed on the second backplane 120 by air extraction, the control module 400 controls the first valve 410 to open and the second valve 420 to close. In the case where the first valve 410 is opened, the air extraction holes 113 work. In the case where the second valve 420 is closed, the glue injection holes 112 do not work. Further, as the air extraction holes 113 work, the control module 400 may adjust the opening degree of the first valve 410, that is, at the beginning of air extraction, the opening degree of the first valve 410 is adjusted to be relatively great to ensure that air extraction is performed through the air extraction holes 113 at a relatively great rate. As air extraction proceeds, the opening degree of the first valve 410 is adjusted to decrease, thereby avoiding the case where air extraction is wasted.

For example, if the current display module 10 requires glue injection, the control module 400 controls the second valve 420 to open, that is, the glue injection holes 112 work. Further, as the glue injection holes 112 work, the control module 400 may adjust the opening degree of the second valve 420, that is, at the beginning of glue injection, the opening degree of the second valve 420 is adjusted to be relatively great to ensure that glue injection is performed through the glue injection holes 112 at a relatively great rate. As glue injection proceeds, the region requiring glue 300 gradually decreases, and then the opening degree of the second valve 420 is adjusted to decrease, thereby avoiding the case where the glue 300 is wasted. Further, during glue injection, the control module 400 may also control the first valve 410 to open and adjust the opening degree of the first valve 410 to be moderate, that is, it is ensured that air extraction is performed through the air extraction holes 113. The moderate air extraction rate facilitates the flow of the glue 300, and at the same time, the glue 300 is not wasted. The specific control process of the first valve 410 and the second valve 420 by the control module 400 may be adaptively adjusted according to actual scenarios. This is not limited in this embodiment of the present disclosure.

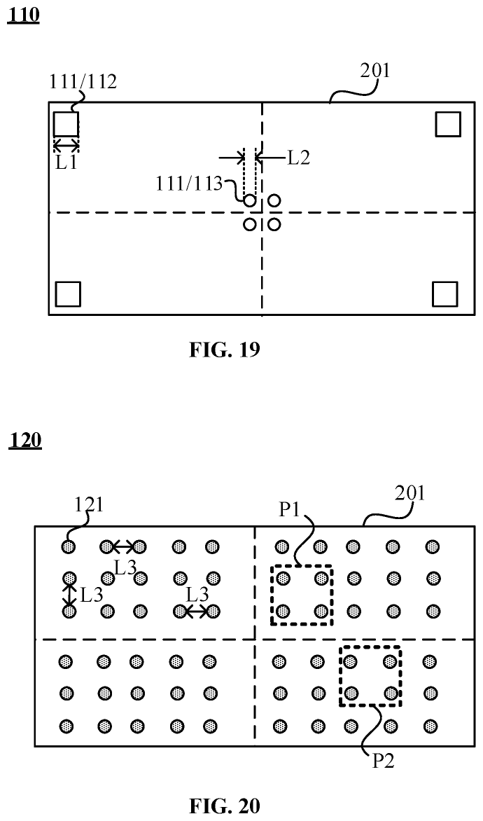

FIG. 18 is a diagram illustrating the structure of another first backplane according to an embodiment of the present disclosure. FIG. 19 is a diagram illustrating the structure of another first backplane according to an embodiment of the present disclosure. With reference to FIGS. 18 and 19, the communication holes 111 include air extraction holes 113 and glue injection holes 112. The air extraction holes 113 are at least configured for performing air extraction on the space between the first backplane 110 and the second backplane 120. The glue injection holes 112 are at least configured for performing glue injection on the space between the first backplane 110 and the second backplane 120. The cross sections of the air extraction holes 113 and the cross sections of the glue injection holes 112 are different.

Specifically, the communication holes 111 include air extraction holes 113 and glue injection holes 112, that is, the air extraction holes 113 and the glue injection holes 112 are located on the first backplane 110 and extend through the first backplane 110. In other words, the disposition positions of the air extraction holes 113 and the disposition positions of the glue injection holes 112 are similar except that there is a difference in the function of the air extraction holes 113 and the function of the glue injection holes 112 in actual applications. Further, to distinguish the air extraction holes 113 and the glue injection holes 112, the cross sections of the air extraction holes 113 and the cross sections of the glue injection holes 112 are different, so that the working effect can be improved in actual production.

For example, with reference to FIG. 18, the section shape of the glue injection holes 112 and the section shape of the air extraction holes 113 are circular. At this time, the size of a section may be adjusted to distinguish the air extraction holes 113 and the glue injection holes 112. For example, the section diameter of the glue injection holes 112 is L1, the section diameter of the air extraction holes 113 is L2, and L1 is greater than L2. With reference to FIG. 19, there is a difference between the section shape of the glue injection holes 112 and the section shape of the air extraction holes 113, that is, the section shape of the glue injection holes 112 may be rectangular, and the section shape of the air extraction holes 113 may be circular. A section shape is adjusted to distinguish the glue injection holes 112 and the air extraction holes 113. It is to be noted that the implementation of the specific cross sections of the glue injection holes 112 and the specific cross sections of the air extraction holes 113 is not limited in this embodiment and may be adaptively adjusted according to actual conditions.

FIG. 20 is a diagram illustrating the structure of another second backplane according to an embodiment of the present disclosure. With reference to FIG. 20, the second backplane 120 includes multiple glue filling holes 121. The multiple glue filling holes 121 are uniformly distributed in the second backplane 120.

Further, the glue filling holes 121 are uniformly distributed in the second backplane 120 corresponding to each panel disposition region 201. In this manner, the adhesive stability and balance of each display panel 200 in the panel disposition region 201 can be ensured, thereby further ensuring the stability of the overall structure of the display module 10. For example, with reference to FIG. 20, the same number of glue filling holes 121 is disposed in the second backplane 120 corresponding to each panel disposition region 201. The distribution density of the glue filling holes 121 is the same per unit area (refer to region P1 and region P2 in FIG. 20), and the distribution number of glue filling holes 121 is the same per unit area (refer to region P1 and region P2 in FIG. 20), which reflects that the multiple glue filling holes 121 are uniformly distributed in the second backplane 120. Further, with reference to FIG. 20, the spacing between any two adjacent glue filling holes 121 in the same direction and the direction perpendicular thereto is L3. The glue filling holes 121 are disposed in each region in a balanced manner, so that it is ensured that the adhesive effect of each display panel 200 is consistent. Moreover, the stability of the structure of the display module 10 is further ensured, and at the same time, the effect displayed by each display panel 200 is ensured to be balanced, thereby reflecting the display balance of the display module 10.

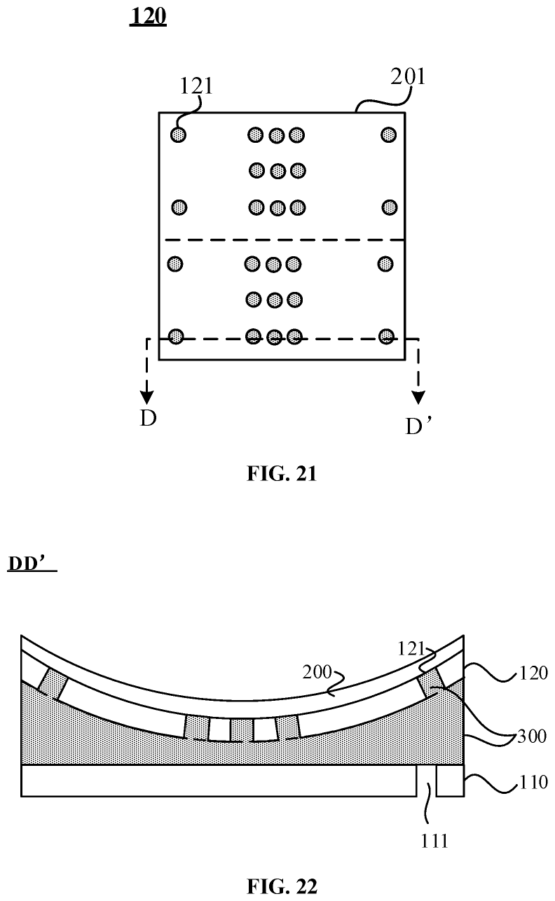

FIG. 21 is a diagram illustrating the structure of another second backplane according to an embodiment of the present disclosure. FIG. 22 is a section view taken along section line D-D′ of FIG. 21. With reference to FIGS. 20 and 21, the second backplane 120 includes a curved backplane. The curved direction of the second backplane 120 faces the light emission side of the display module 10. The second backplane 120 includes multiple glue filling holes 121. The distribution density of glue filling holes 121 at the center of the second backplane 120 is greater than the distribution density of glue filling holes 121 at an edge corner of the second backplane 120.

Specifically, the second backplane 120 may be a backplane of a curved shape, that is, with reference to FIG. 22, the curved direction of the second backplane 120 faces the light emission side of the display module 10. That is, the edge region of the second backplane 120 is curved in a direction away from the first backplane 110. In other words, the spacing between the center region of the second backplane 120 and the center region of the first backplane 110 is less than the spacing between the edge region of the second backplane 120 and the edge region of the first backplane 110. Based on the preceding second backplane 120 of the curved shape, the disposition positions of multiple glue filling holes 121 in the second backplane 120 may be adjusted. In this manner, it is ensured that the non-planar second backplane 120 and the display panels 200 on the second backplane 120 can be stably adhered, thereby ensuring the stability of the overall structure of the display module 10.

Further, with reference to FIG. 22, based on the curved shape of the second backplane 120, the display panels 200 adjacent to the center region of the backplanes 100 require greater adhesion to ensure that the display panels 200 are stably adhered to the second backplane 120. The distribution density of glue filling holes 121 in the second backplane 120 is adjusted to ensure the adhesive effect of each region of the display panels 200, thereby ensuring the stability of the structure of the display module 10. Specifically, with reference to FIG. 21, the distribution density of glue filling holes 121 at the center of the second backplane 120 is greater than the distribution density of glue filling holes 121 at an edge corner of the second backplane 120. The distribution density may refer to a difference in the number of glue filling holes 121 of the same size or may refer to a difference in the cross-section areas of the glue filling holes 121 of different sizes. This is not limited in this embodiment of the present disclosure. The distribution density of the glue filling holes 121 in the center region is increased, so that it is ensured that the glue 300 in the center region is in contact with the display panels 200 in a greater area, thereby ensuring the greater adhesion required for the display panels 200.

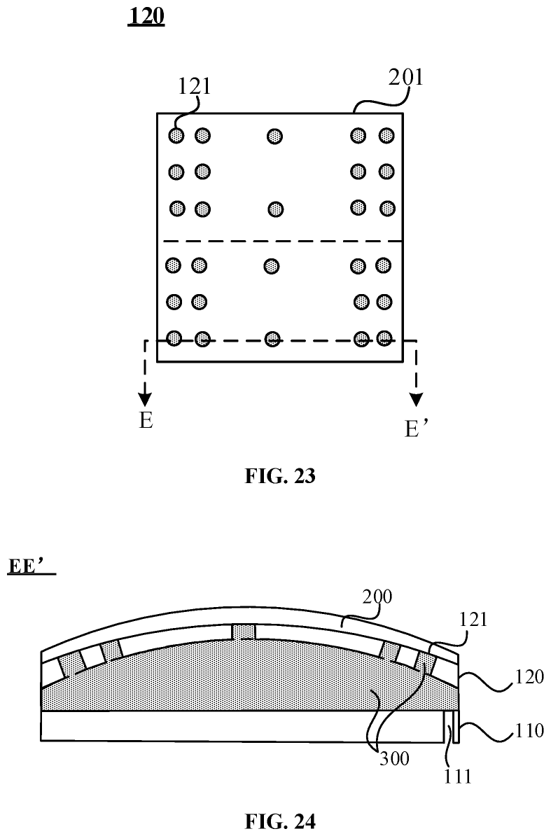

FIG. 23 is a diagram illustrating the structure of another second backplane according to an embodiment of the present disclosure. FIG. 24 is a section view taken along section line E-E′ of FIG. 23. With reference to FIGS. 23 and 24, the second backplane 120 includes a curved backplane. The curved direction of the second backplane 120 faces away from the light emission side of the display module 10. The second backplane 120 includes multiple glue filling holes 121. The distribution density of glue filling holes 121 at the center of the second backplane 120 is less than the distribution density of glue filling holes 121 at an edge of the second backplane 120.

Specifically, the second backplane 120 may be a backplane of a curved shape, that is, with reference to FIG. 24, the curved direction of the second backplane 120 faces away from the light emission side of the display module 10. That is, the edge region of the second backplane 120 is curved in a direction adjacent to the first backplane 110. In other words, the spacing between the center region of the second backplane 120 and the center region of the first backplane 110 is greater than the spacing between the edge region of the second backplane 120 and the edge region of the first backplane 110. Based on the preceding second backplane 120 of the curved shape, the disposition positions of multiple glue filling holes 121 in the second backplane 120 may be adjusted. In this manner, it is ensured that the non-planar second backplane 120 and the display panels 200 on the second backplane 120 can be stably adhered, thereby ensuring the stability of the overall structure of the display module 10.

Further, with reference to FIG. 24, based on the curved shape of the second backplane 120, the display panels 200 adjacent to the edge region of the backplanes 100 require greater adhesion to ensure that the display panels 200 are stably adhered to the second backplane 120. The distribution density of glue filling holes 121 in the second backplane 120 is adjusted to ensure the adhesive effect of each region of the display panels 200, thereby ensuring the stability of the structure of the display module 10. Specifically, with reference to FIG. 23, the distribution density of glue filling holes 121 at the center of the second backplane 120 is less than the distribution density of glue filling holes 121 at an edge corner of the second backplane 120. The distribution density may refer to a difference in the number of glue filling holes 121 of the same size or may refer to a difference in the cross-section areas of the glue filling holes 121 of different sizes. This is not limited in this embodiment of the present disclosure. The distribution density of the glue filling holes 121 in the edge region is increased, so that it is ensured that the glue 300 in the edge region is in contact with the display panels 200 in a greater area, thereby ensuring the greater adhesion required for the display panels 200.

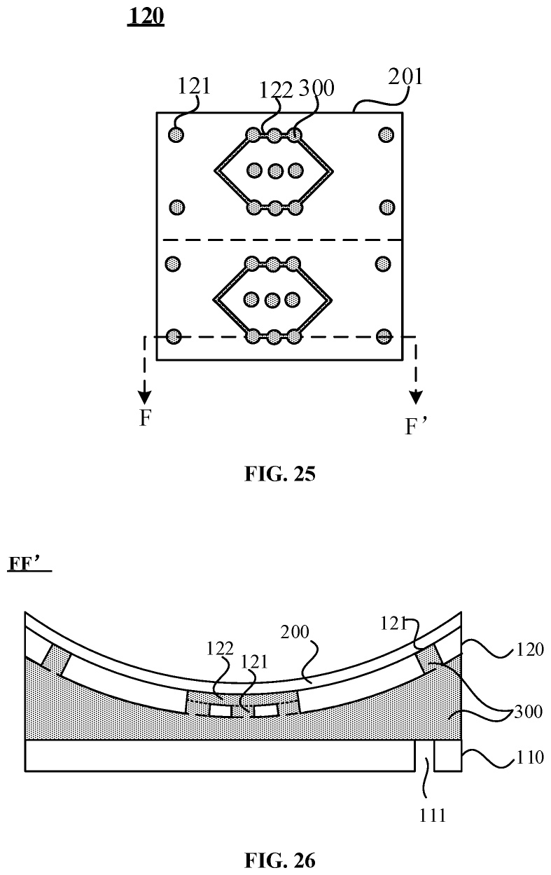

FIG. 25 is a diagram illustrating the structure of another second backplane according to an embodiment of the present disclosure. FIG. 26 is a section view taken along section line F-F′ of FIG. 25. With reference to FIGS. 25 and 26, the second backplane 120 includes a curved backplane. The curved direction of the second backplane 120 faces the light emission side of the display module 10. A first groove 122 is disposed at the center of the surface of the side of the second backplane 120 facing away from the first backplane 110. The glue 300 is disposed in the first groove 122.

Further, with reference to FIG. 26, based on the curved shape of the second backplane 120, the display panels 200 adjacent to the central region of the backplanes 100 require greater adhesion to ensure that the display panels 200 are stably adhered to the second backplane 120. The first groove 122 is disposed in the second backplane 120, and the first groove 122 is disposed around the central region of the second backplane 120, so that the adhesion of the display panels 200 and the second backplane 120 in the center region is improved by the presence of the glue 300 in the first groove 122, thereby ensuring the stability of the overall structure of the display module 10. In other words, the contact area between the glue 300 in the center region of the second backplane 120 and the display panels 200 is increased, thereby ensuring the greater adhesion required for the display panels 200.

FIG. 27 is a diagram illustrating the structure of another second backplane according to an embodiment of the present disclosure. With reference to FIG. 27, the second backplane 120 includes a curved backplane. The curved direction of the second backplane 120 faces away from the light emission side of the display module 10. A second groove 123 is disposed at an edge of the surface of the side of the second backplane 120 facing away from the first backplane 110. The glue 300 is disposed in the second groove 123.

Further, with reference to FIG. 27, based on the curved shape of the second backplane 120, the display panels 200 adjacent to the edge region of the backplanes 100 require greater adhesion to ensure that the display panels 200 are stably adhered to the second backplane 120. The second groove 123 is disposed in the second backplane 120 to ensure the adhesive effect of each region of the display panels 200, thereby ensuring the stability of the structure of the display module 10. Specifically, with reference to FIG. 27, the second groove 123 is located at an edge of the second backplane 120, so that the adhesion of the display panels 200 and the second backplane 120 in the edge region is improved by the presence of the glue 300 in the second groove 123, thereby ensuring the stability of the overall structure of the display module 10. In other words, the contact area between the glue 300 in the edge region of the second backplane 120 and the display panels 200 is increased, thereby ensuring the greater adhesion required for the display panels 200.

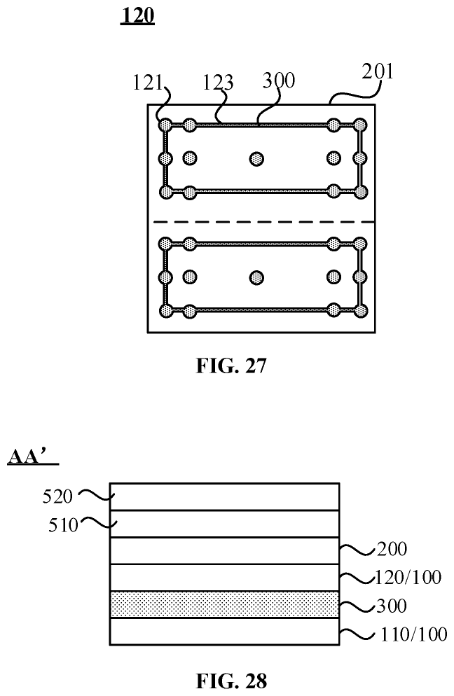

FIG. 28 is another section view taken along section line A-A′ of FIG. 1. With reference to FIG. 28, the display module 10 also includes adhesive glue 510 and a protective cover plate 520 located on the side of the display panels 200 facing away from the backplanes 100.

Specifically, with reference to FIG. 28, a protective structure is also disposed on the side of the display panels 200 facing away from the backplanes 100, that is, the protective cover plate 520 and the adhesive glue 510 between the protective cover plate 520 and the display panels 200. For example, the protective cover plate 520 may be a glass cover plate. The specific material of the protective structure is not limited in this embodiment of the present disclosure. The adhesive glue 510 and the protective cover 520 are continuously added on the display panels 200, thereby further ensuring the stability of the structure of the display module 10.

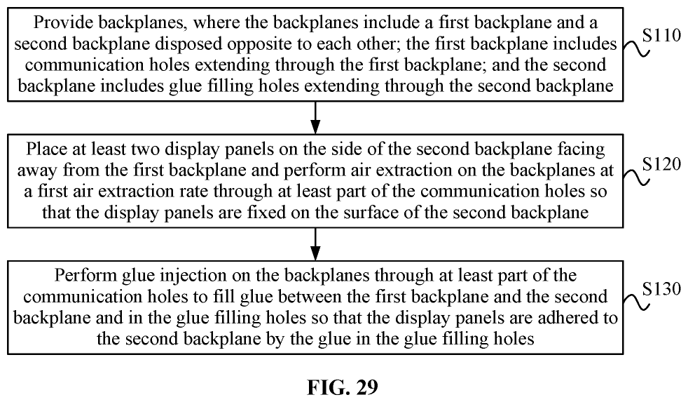

Based on the same inventive concept, an embodiment of the present disclosure provides a preparation method of a display module. FIG. 29 is a flowchart of a preparation method of a display module according to an embodiment of the present disclosure. As shown in FIG. 29, the preparation method includes the steps below.

In S110, the backplanes are provided. The backplanes include a first backplane and a second backplane disposed opposite to each other. The first backplane includes communication holes extending through the first backplane. The second backplane includes glue filling holes extending through the second backplane.

Further, the display module also includes backplanes. The backplanes include a first backplane and a second backplane. Subsequently, the display panels are located on and fitted against the side of the second backplane facing away from the first backplane. That is, the backplanes serve as the support structure for the display panels and provide space for multiple display panels when combined together, thereby ensuring that the display module can implement a display effect of a large area in which multiple display panels 200 are spliced.

Specifically, the first backplane includes communication holes extending through the first backplane. Air extraction is performed through the communication holes, and negative pressure is formed in the space between the first backplane and the second backplane, so that the display panels located on the side of the second backplane facing away from the first backplane are stably adsorbed on the second backplane. At the same time, the subsequently filled glue is also injected between the first backplane and the second backplane through the communication holes. Further, the second backplane includes glue filling holes extending through the second backplane.

In S120, at least two display panels are placed on the side of the second backplane facing away from the first backplane. Air extraction is performed on the backplanes at a first air extraction rate through at least part of the communication holes so that the display panels are fixed on the surface of the second backplane.

The display module includes a display panel. The display panel has a display function, thereby implementing the display effect of the display module. For example, the display panel may be a liquid-crystal display panel or may be an organic light-emitting display panel. The specific type of the display panel is not limited in this embodiment of the present disclosure. Further, the display module includes at least two display panels, that is, multiple display panels may be combined and spliced, thereby implementing the display effect of a large size of the display module and ensuring the better overall display effect of the display module.

Specifically, the communication holes in the first backplane have two functions: air extraction and glue injection. Specifically, for air extraction, that is, after the first backplane, the second backplane, and the display panels are placed in designed relative positions, air extraction is performed on the communication holes at the first air extraction rate. The air between the first backplane and the second backplane is extracted. In this manner, negative pressure is formed between the first backplane and the second backplane relative to other positions, thereby ensuring that the display panels are better adhered to the second backplane, and that the display panels are stably fixed at the position of the second backplane during subsequent glue injection.

In S130, glue injection is performed on the backplanes through at least part of the communication holes to fill the glue between the first backplane and the second backplane and in the glue filling holes so that the display panels are adhered to the second backplane by the glue in the glue filling holes.

The glue is disposed between the first backplane and the second backplane. The backplanes and the display panels are fixed by the glue, thereby ensuring the stability of the structure of the display module.

Further, for the glue injection process through the communication holes, that is, the glue is injected between the first backplane and the second backplane through the communication holes to ensure that the first backplane is adhered to the second backplane, thereby ensuring that the first backplane is fixedly connected to the second backplane. At the same time, the second backplane includes the glue filling holes. The glue injected through the communication holes also flows between the second backplane and the display panel through the glue filling holes, thereby ensuring the fixed connection effect between the second backplane and the display panels. In general, glue injection and air extraction are performed through the communication holes to ensure the stable connection of the structure between the first backplane, the second backplane, and the display panels, thereby ensuring the stability of the structure of the display module.

Specifically, the glue fills the glue filling holes, that is, the glue is facilitated to flow between the second backplane and the display panels through the glue filling holes, thereby ensuring that the display panels are in fixed contact with the second backplane. For example, air extraction and glue injection are implemented through the communication holes of the first backplane. The glue flows through the glue filling holes of the second backplane, so that it is ensured that the display panels are adhered to the second backplane by the glue in the glue filling holes, thereby ensuring the stability of the overall structure of the display module. Moreover, it is ensured that multiple display panels are fixedly disposed in the display module, thereby implementing a display effect of a large size.

In summary, in the preparation method provided by this embodiment of the present disclosure, the communication holes in the first backplane ensure stable placement of the display panels, and the glue filling holes in the second backplane allows the glue to fix the display panels, thereby ensuring the stability of the structure of the display module and the overall display effect of the display module.

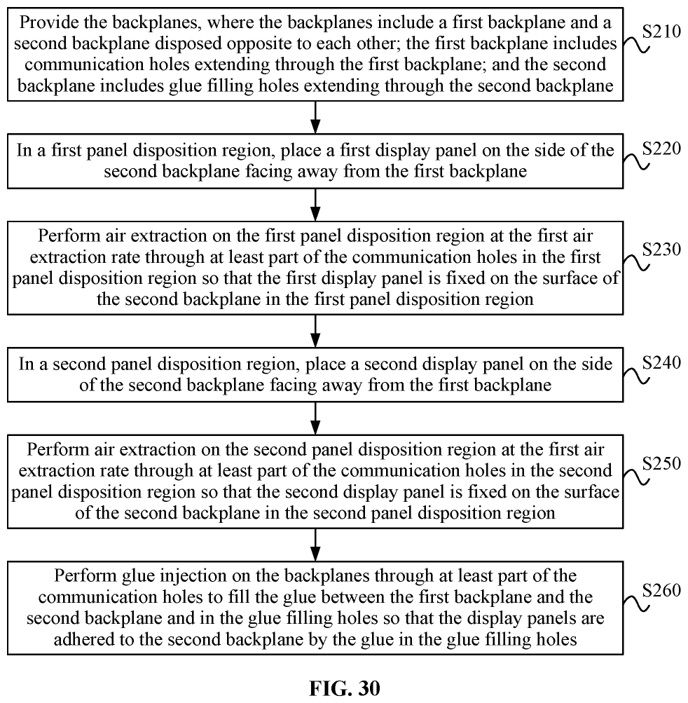

FIG. 30 is a flowchart of another preparation method of a display module according to an embodiment of the present disclosure. With reference to FIG. 30, the preparation method of a display module also includes the steps below.

In S210, the backplanes are provided. The backplanes include a first backplane and a second backplane disposed opposite to each other. The first backplane includes communication holes extending through the first backplane. The second backplane includes glue filling holes extending through the second backplane.

In S220, in a first panel disposition region, a first display panel is placed on the side of the second backplane facing away from the first backplane.

In S230, air extraction is performed on the first panel disposition region at the first air extraction rate through at least part of the communication holes in the first panel disposition region so that the first display panel is fixed on the surface of the second backplane in the first panel disposition region.

In S240, in a second panel disposition region, a second display panel is placed on the side of the second backplane facing away from the first backplane.

In S250, air extraction is performed on the second panel disposition region at the first air extraction rate through at least part of the communication holes in the second panel disposition region so that the second display panel is fixed on the surface of the second backplane in the second panel disposition region.

For example, a description is given by using an example in which the display module includes two display panels, that is, the panel disposition regions corresponding to different display panels are the first panel disposition region and the second panel disposition region respectively. Specifically, a display panel is disposed in the first panel disposition region, that is, the display panel is in contact with the corresponding second backplane. Air extraction is performed through the corresponding communication holes at the first air extraction rate, that is, the display panel is ensured to be fixedly adsorbed in the first panel disposition region. Similarly, another display panel is disposed in the second panel disposition region, that is, the display panel is in contact with the corresponding second backplane. Air extraction is performed through the corresponding communication holes at the first air extraction rate, that is, the display panel is ensured to be fixedly adsorbed in the second panel disposition region. That is, air extraction is performed on the communication holes corresponding to the different panel disposition regions at different times. That is, different display panels may be independently placed and independently adsorbed and adhered to the second backplane to ensure that when the display module includes multiple display panels, different display panels are independently controlled. In this manner, the control accuracy of the overall display module is improved, and the adhesion of each display panel in the display module is ensured, thereby ensuring that the overall display effect of the display module is better.

In S260, glue injection is performed on the backplanes through at least part of the communication holes to fill the glue between the first backplane and the second backplane and in the glue filling holes so that the display panels are adhered to the second backplane by the glue in the glue filling holes.

In summary, in this embodiment of the present disclosure, different display panels are independently controlled, thereby ensuring that the overall display effect of the display module is better.

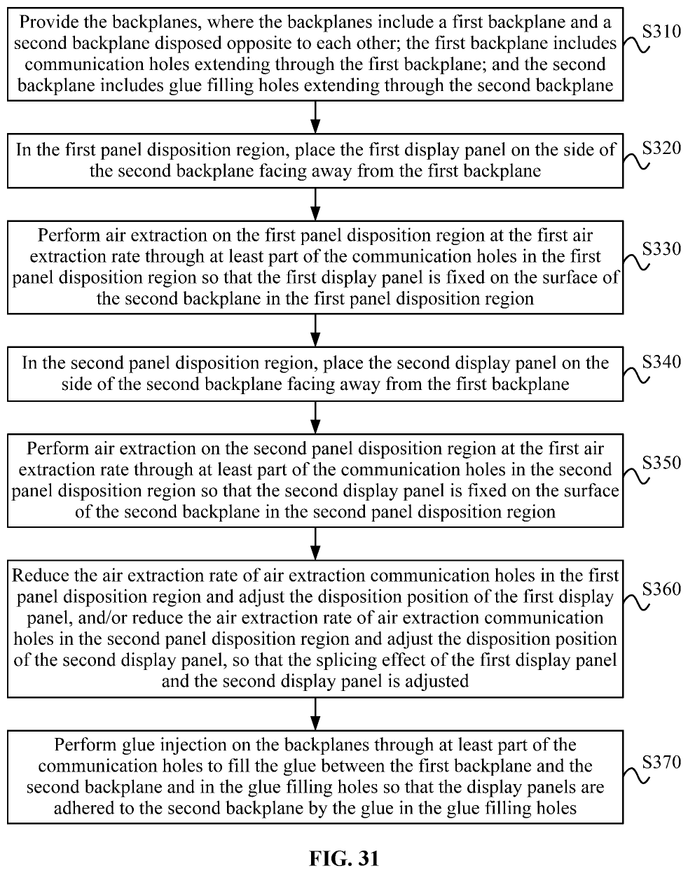

FIG. 31 is a flowchart of another preparation method of a display module according to an embodiment of the present disclosure. With reference to FIG. 31, the preparation method of a display module also includes the steps below.

In S310, the backplanes are provided. The backplanes include a first backplane and a second backplane disposed opposite to each other. The first backplane includes communication holes extending through the first backplane. The second backplane includes glue filling holes extending through the second backplane.

In S320, in the first panel disposition region, the first display panel is placed on the side of the second backplane facing away from the first backplane.

In S330, air extraction is performed on the first panel disposition region at the first air extraction rate through at least part of the communication holes in the first panel disposition region so that the first display panel is fixed on the surface of the second backplane in the first panel disposition region.

In S340, in the second panel disposition region, the second display panel is placed on the side of the second backplane facing away from the first backplane.

In S350, air extraction is performed on the second panel disposition region at the first air extraction rate through at least part of the communication holes in the second panel disposition region so that the second display panel is fixed on the surface of the second backplane in the second panel disposition region.

In S360, the air extraction rate of air extraction communication holes in the first panel disposition region is reduced, and the disposition position of the first display panel is adjusted. Moreover/Alternatively, the air extraction rate of air extraction communication holes in the second panel disposition region is reduced, and the disposition position of the second display panel is adjusted. In this manner, the splicing effect of the first display panel and the second display panel is adjusted.

Further, for the air extraction process through the communication holes, air extraction may be performed at a relatively great air extraction rate at the beginning of the air extraction process to ensure the adsorption effect of each display panel. As the air extraction process proceeds, the air volume between the first backplane and the second backplane is gradually reduced. Then the air extraction rate of the communication holes may be reduced, thereby avoiding the waste of air extraction. At the same time, if the air extraction is always performed at a relatively great air extraction rate during a glue injection process, the glue is extracted. As a result, the glue injection effect is affected.

Further, when the first display panel and the second display panel are adhered to the surface of the second backplane based on the effect of pressure, the air extraction rate of air extraction communication holes in the first panel disposition region may be reduced, and the disposition position of the first display panel is adjusted; and/or the air extraction rate of air extraction communication holes in the second panel disposition region is reduced, and the disposition position of the second display panel is adjusted. In this manner, the position of the first display panel and/or the position of the second display panel are adjusted to adjust the splicing effect of the first display panel and the second display panel. For example, the joint between the first display panel and the second display panel is reduced to avoid a great joint between the first display panel and the second display panel. In this manner, it is ensured that the splicing effect between different display panels is good, and it is further ensured that the display effect of the display module is good.

In S370, glue injection is performed on the backplanes through at least part of the communication holes to fill the glue between the first backplane and the second backplane and in the glue filling holes so that the display panels are adhered to the second backplane by the glue in the glue filling holes.

In summary, the air extraction rate of the communication holes is adjusted, that is, air extraction is performed at the first air extraction rate to ensure that the display panels are initially fixed in a panel disposition region. The air extraction rate is reduced to further adjust the relative positions of the display panels. In general, the precise control of the positions of the display panels may be further ensured.

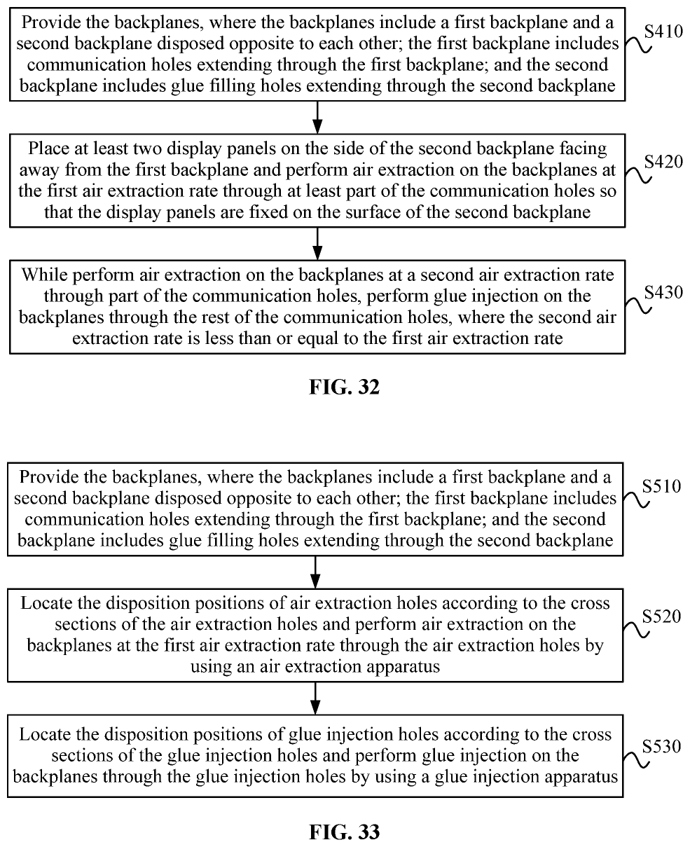

FIG. 32 is a flowchart of another preparation method of a display module according to an embodiment of the present disclosure. With reference to FIG. 32, the preparation method of a display module also includes the steps below.

In S410, the backplanes are provided. The backplanes include a first backplane and a second backplane disposed opposite to each other. The first backplane includes communication holes extending through the first backplane. The second backplane includes glue filling holes extending through the second backplane.

In S420, at least two display panels are placed on the side of the second backplane facing away from the first backplane. Air extraction is performed on the backplanes at the first air extraction rate through at least part of the communication holes so that the display panels are fixed on the surface of the second backplane.

In S430, while air extraction is performed on the backplanes at a second air extraction rate through part of the communication holes, glue injection is performed on the backplanes through the rest of the communication holes. The second air extraction rate is less than or equal to the first air extraction rate.

Air extraction may first be performed through part of the communication holes at the first air extraction rate, so that negative pressure is formed to ensure that the display panels are fixed at approximate positions. Then glue injection is performed to ensure the overall fixed effect of the display panels and the backplanes. Further, when glue injection is performed through part of the communication holes, air extraction may be performed through the other communication holes at the second air extraction rate. In this manner, it is ensured that the glue injected by the other communication hole flows by air extraction to ensure uniform dispersion of the glue. There is a difference between the function implemented by the first air extraction and the function implemented by the second air extraction, that is, the second air extraction rate is less than or equal to the first air extraction rate. Thus, the overall fixed effect is further ensured, thereby ensuring the stability of the structure of the display module.

In summary, through the efficient use of communication holes, the preparation time and cost of the display module are reduced, and the structural stability and the display effect of the display module can also be ensured.

FIG. 33 is a flowchart of another preparation method of a display module according to an embodiment of the present disclosure. With reference to FIG. 33, the preparation method of a display module also includes the steps below.

In S510, the backplanes are provided. The backplanes include a first backplane and a second backplane disposed opposite to each other. The first backplane includes communication holes extending through the first backplane. The second backplane includes glue filling holes extending through the second backplane.

In S520, the disposition positions of the air extraction holes are located according to the cross sections of the air extraction holes. Air extraction is performed on the backplanes at the first air extraction rate through the air extraction holes by using an air extraction apparatus.

In S530, the disposition positions of the glue injection holes are located according to the cross sections of the glue injection holes. Glue injection is performed on the backplanes through the glue injection holes by using a glue injection apparatus.

Specifically, the communication holes include air extraction holes and glue injection holes, that is, the air extraction holes and the glue injection holes are located on the first backplane and extend through the first backplane. In other words, the disposition positions of the air extraction holes and the disposition positions of the air extraction holes are similar except that there is a difference in the function of the air extraction holes and the function of the glue injection holes in actual applications. Further, to distinguish the air extraction holes and the glue injection holes, the cross sections of the air extraction holes and the cross sections of the glue injection holes are different, so that the working effect can be improved in actual production.

For example, the section shape of the glue injection holes and the section shape of the air extraction holes are circular. The size of a section image is adjusted to distinguish the glue injection holes and the air extraction holes. That is, the section diameter of the glue injection holes is L1, the section diameter of the air extraction holes is L2, and L1 is greater than L2. There is a difference between the section shape of the glue injection holes and the section shape of the air extraction holes, that is, the section shape of the glue injection holes may be rectangular, and the section shape of the air extraction holes may be circular. The shape of a section image is adjusted to distinguish the glue injection holes and the air extraction holes. In the case where it is convenient to distinguish the air extraction holes and the glue injection holes, air extraction is performed on the backplanes at the first air extraction rate through the air extraction holes by using the air extraction apparatus, and glue injection is performed on the backplanes through the glue injection holes by using the glue injection apparatus. It is to be noted that the size relationship of the specific cross sections of the glue injection holes and the specific cross sections of the air extraction holes is not limited in this embodiment and may be adaptively adjusted according to actual conditions.

Optionally, after glue injection is performed on the backplanes through the glue injection holes by using the glue injection apparatus, the adhesive glue and the protective cover plate may also be prepared on the side of the display panels facing away from the backplanes.

Specifically, the protective structure is also disposed on the side of the display panels facing away from the backplanes, that is, the protective cover plate and the adhesive glue between the protective cover plate and the display panels. For example, the protective cover plate may be a glass cover plate. The specific material of the protective structure is not limited in this embodiment of the present disclosure. The adhesive glue and the protective cover are continuously added on the display panels, thereby further ensuring the stability of the structure of the display module.

In summary, the glue injection holes and the air extraction holes having a small difference in disposition positions are distinguished in terms of a cross sectional area, it is convenient to distinguish the glue injection holes and the air extraction holes in the actual process. The glue injection holes and the air extraction holes work based on different devices, that is, the air extraction apparatus and the glue injection apparatus, thereby improving the working efficiency.

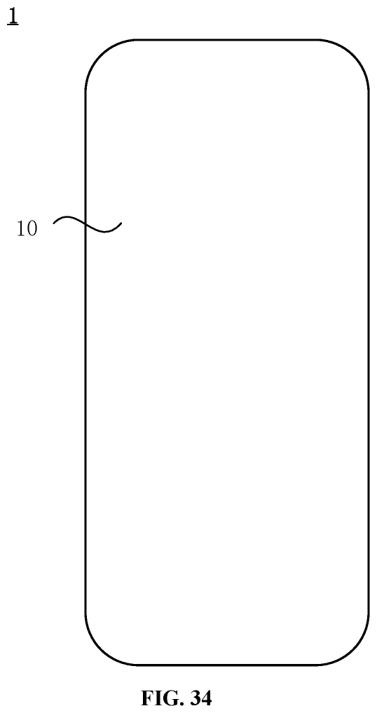

Based on the same inventive concept, an embodiment of the present disclosure provides a display device. FIG. 34 is a view illustrating the structure of a display device according to an embodiment of the present disclosure. As shown in FIG. 34, the display device 1 includes the display module 10 described in any of the preceding embodiments. Thus, the display device 1 provided in this embodiment of the present application has the corresponding beneficial effects in the preceding embodiments, and the details are not repeated here. Exemplarily, the display device 1 may be a mobile phone, a computer, a smart wearable device (for example, a smart watch), an onboard display device, and other electronic devices. This is not limited in this embodiment of the present disclosure.

It is to be noted that the preceding are only preferred embodiments of the present disclosure and the principles used therein. It is to be understood by those skilled in the art that the present disclosure is not limited to the embodiments described herein. For those skilled in the art, various apparent modifications, adaptations and substitutions can be made without departing from the scope of the present disclosure. Therefore, while the present disclosure is described in detail in connection with the preceding embodiments, the present disclosure is not limited to the preceding embodiments and may include equivalent embodiments without departing from the concept of the present disclosure. The scope of the present disclosure is determined by the scope of the appended claims.

What is claimed is:

1. A display module, comprising backplanes and at least two display panels disposed on a side of the backplanes, wherein
the backplanes comprise a first backplane and a second backplane disposed opposite to each other and glue between the first backplane and the second backplane; the first backplane comprises communication holes extending through the first backplane; the second backplane comprises glue filling holes extending through the second backplane, and the glue fills the glue filling holes; and
the at least two display panels are located on a side of the second backplane facing away from the first backplane, overlap the glue filling holes in a thickness direction of the display module, and are adhered to the second backplane by the glue in the glue filling holes.

2. The display module according to claim 1, wherein the communication holes are configured for performing air extraction and glue injection on space between the first backplane and the second backplane in a time-sharing manner.

3. The display module according to claim 1, wherein part of the communication holes are configured for performing air extraction and glue injection on space between the first backplane and the second backplane in a time-sharing manner, and rest of the communication holes are configured for performing glue injection on the space between the first backplane and the second backplane.

4. The display module according to claim 1, wherein part of the communication holes are configured for performing air extraction and glue injection on space between the first backplane and the second backplane in a time-sharing manner, and rest of the communication holes are configured for performing air extraction on the space between the first backplane and the second backplane.

5. The display module according to claim 1, wherein the backplanes comprise at least two panel disposition regions, and the at least two display panels are disposed in the at least two panel disposition regions; and
two panel disposition regions are disposed, and a number of communication holes in a panel disposition region of the two panel disposition regions adjacent to an edge of the backplanes is greater than a number of communication holes in a panel disposition region of the two panel disposition regions adjacent to a center of the backplanes.

6. The display module according to claim 1, wherein the backplanes comprise at least two panel disposition regions, and the at least two display panels are disposed in the at least two panel disposition regions;
the communication holes comprise glue injection holes, and the glue injection holes are at least configured for performing glue injection on space between the first backplane and the second backplane; and
two panel disposition regions are disposed, and a number of glue injection holes in a panel disposition region of the two panel disposition regions adjacent to an edge of the backplanes is less than a number of glue injection holes in a panel disposition region of the two panel disposition regions adjacent to a center of the backplanes.

7. The display module according to claim 1, wherein the backplanes comprise at least two panel disposition regions, and the at least two display panels are disposed in the at least two panel disposition regions; and
the first backplane in each of the at least two panel disposition regions comprises communication holes, and the second backplane in the each panel disposition region comprises glue filling holes.

8. The display module according to claim 7, wherein in the each panel disposition region, the first backplane comprises at least two of the communication holes;
two of the at least two communication holes are disposed on two opposite sides of a center of the each panel disposition region; or
at least one of the at least two communication holes is disposed at a center of the each panel disposition region, and at least one of the at least two communication holes is disposed at an edge of the each panel disposition region.

9. The display module according to claim 1, wherein the communication holes comprise air extraction holes and glue injection holes, the air extraction holes are at least configured for performing air extraction on space between the first backplane and the second backplane, and the glue injection holes are at least configured for performing glue injection on the space between the first backplane and the second backplane;
the air extraction holes and the glue injection holes are independently disposed; and
the backplanes further comprise a first valve and a second valve, the first valve is configured to control an opening degree state of the air extraction holes, and the second valve is configured to control an opening degree state of the glue injection holes.

10. The display module according to claim 1, wherein the communication holes comprise air extraction holes and glue injection holes, the air extraction holes are at least configured for performing air extraction on space between the first backplane and the second backplane, and the glue injection holes are at least configured for performing glue injection on the space between the first backplane and the second backplane; and
cross sections of the air extraction holes and cross sections of the glue injection holes are different.

11. The display module according to claim 1, wherein the second backplane comprises a plurality of glue filling holes, and the plurality of glue filling holes are uniformly distributed in the second backplane.

12. The display module according to claim 1, wherein the second backplane comprises a curved backplane, and a curved direction of the second backplane faces a light emission side of the display module; and
the second backplane comprises a plurality of glue filling holes, and distribution density of glue filling holes of the plurality of glue filling holes at a center of the second backplane is greater than distribution density of glue filling holes of the plurality of glue filling holes at an edge corner of the second backplane.

13. The display module according to claim 1, wherein the second backplane comprises a curved backplane, and a curved direction of the second backplane faces away from a light emission side of the display module; and
the second backplane comprises a plurality of glue filling holes, and distribution density of glue filling holes of the plurality of glue filling holes at a center of the second backplane is less than distribution density of glue filling holes of the plurality of glue filling holes at an edge of the second backplane.

14. The display module according to claim 1, wherein the second backplane comprises a curved backplane, and a curved direction of the second backplane faces a light emission side of the display module; and a first groove is disposed at a center of a surface of the side of the second backplane facing away from the first backplane, and the glue is disposed in the first groove;
or/and, the second backplane comprises a curved backplane, and a curved direction of the second backplane faces away from a light emission side of the display module; and a second groove is disposed at an edge of a surface of the side of the second backplane facing away from the first backplane, and the glue is disposed in the second groove.

15. A preparation method of a display module, comprising:
providing backplanes, wherein the backplanes comprise a first backplane and a second backplane disposed opposite to each other; the first backplane comprises communication holes extending through the first backplane; and the second backplane comprises glue filling holes extending through the second backplane;
placing at least two display panels on a side of the second backplane facing away from the first backplane and performing air extraction on the backplanes at a first air extraction rate through at least part of the communication holes so that the at least two display panels are fixed on a surface of the second backplane; and
performing glue injection on the backplanes through at least part of the communication holes to fill glue between the first backplane and the second backplane and in the glue filling holes so that the at least two display panels are adhered to the second backplane by the glue in the glue filling holes.

16. The preparation method according to claim 15, wherein the backplanes at least comprise a first panel disposition region and a second panel disposition region, and the first backplane in each panel disposition region comprises communication holes;
the at least two display panels comprise a first display panel and a second display panel; and
placing the at least two display panels on the side of the second backplane facing away from the first backplane and performing the air extraction on the backplanes at the first air extraction rate through the at least part of the communication holes so that the at least two display panels are fixed on the surface of the second backplane comprise:
in the first panel disposition region, placing the first display panel on the side of the second backplane facing away from the first backplane;
performing air extraction on the first panel disposition region at the first air extraction rate through at least part of the communication holes in the first panel disposition region so that the first display panel is fixed on the surface of the second backplane in the first panel disposition region;
in the second panel disposition region, placing the second display panel on the side of the second backplane facing away from the first backplane; and
performing air extraction on the second panel disposition region at the first air extraction rate through at least part of the communication holes in the second panel disposition region so that the second display panel is fixed on the surface of the second backplane in the second panel disposition region.

17. The preparation method according to claim 15, before performing the glue injection on the backplanes through the at least part of the communication holes, further comprising:
reducing an air extraction rate of communication holes in the first panel disposition region and adjusting a disposition position of the first display panel, and/or reducing an air extraction rate of communication holes in the second panel disposition region and adjusting a disposition position of the second display panel, so that a splicing effect of the first display panel and the second display panel is adjusted.

18. The preparation method according to claim 15, wherein performing the glue injection on the backplanes through the at least part of the communication holes comprises:
while performing air extraction on the backplanes at a second air extraction rate through part of the communication holes, performing glue injection on the backplanes through rest of the communication holes, wherein the second air extraction rate is less than or equal to the first air extraction rate.

19. The preparation method according to claim 15, wherein the communication holes comprise air extraction holes and glue injection holes, and cross sections of the air extraction holes and cross sections of the glue injection holes are different;
performing the air extraction on the backplanes at the first air extraction rate through the at least part of the communication holes comprises:
locating disposition positions of the air extraction holes according to the cross sections of the air extraction holes and performing air extraction on the backplanes at the first air extraction rate through the air extraction holes by using an air extraction apparatus; and
performing the glue injection on the backplanes through the at least part of the communication holes comprises:
locating disposition positions of the glue injection holes according to the cross sections of the glue injection holes and performing glue injection on the backplanes through the glue injection holes by using a glue injection apparatus.

20. A display device, comprising a display module, wherein the display module comprises backplanes and at least two display panels disposed on a side of the backplanes, wherein the backplanes comprise a first backplane and a second backplane disposed opposite to each other and glue between the first backplane and the second backplane; the first backplane comprises communication holes extending through the first backplane; the second backplane comprises glue filling holes extending through the second backplane, and the glue fills the glue filling holes; and
the at least two display panels are located on a side of the second backplane facing away from the first backplane, overlap the glue filling holes in a thickness direction of the display module, and are adhered to the second backplane by the glue in the glue filling holes.
